(19) United States
(12) Patent Application Publication
(10) Pub. No.: US 2025/0238252 A1
(43) Pub. Date: Jul. 24, 2025

(54) MUTUAL AUTHENTICATION BETWEEN WORKLOADS AND A HOST MEMORY BUFFER FOR CONFIDENTIAL AND SECURE MEMORY MANAGEMENT SYSTEMS

(71) Applicant: Dell Products L.P., Round Rock, TX (US)

(72) Inventors: Nicholas D. GROBELNY, Evergreen (TX); Shekar Babu SURYANARAYANA, Bangalore (IN); Daniel L. HAMLIN, Round Rock, TX (US)

(73) Assignee: Dell Products L.P., Round Rock, TX (US)

(21) Appl. No.: 18/421,485

(22) Filed: Jan. 24, 2024

(51) Int. Cl. G06F 9/455

(52) U.S. Cl. CPC G06F 9/45558; G06F 2009/45583; G06F 2009/45587

(57) ABSTRACT

Disclosed systems and methods respond to detecting an application workload requesting access to a host memory buffer (HMB) associated with a nonvolatile storage device of an information handling system by performing mutual authentication operations. The mutual authentication operations may include authenticating the application to the HMB and authenticating the HMB to the application. Responsive to successful completion of the mutual authentication operations, disclosed methods and systems may establish a secure communications tunnel enabling the application workload to access at least a portion of the HMB securely.

### TECHNICAL FIELD

The present disclosure pertains to information handling systems and, more particularly, memory or storage resources such as Non-Volatile Memory Express (NVMe) storage in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

NVMe is an industry standard interface specification enabling host software to communicate with non-volatile memory subsystems. Enterprise class and client level NVMe-compliant devices, referred to herein simply as NVMe devices, are often implemented as solid state drives (SSDs) attached as a register level interface to the Peripheral Components Interface (PCI) Express (PCIe) bus. Beginning with NVMe version 1.2, introduced in late 2014, NVMe SSDs support a Host Memory Buffer (HMB) feature that provides an HMB controller with exclusive access to an assigned portion of host system memory.

Establishing a trustworthy connection between the HMB controller and each individual workload is required for proper access control, to prevent spoofing attacks in which malicious applications “pretend” to be valid ones and inject or exfiltrate data into HMB regions that were authorized for valid workloads only. Additionally, it may be possible to mount “in the middle” attacks between valid HMBs and legitimate workloads for the purposes of modifying commands or data, or exfiltrating data. There is a need to protect both the confidentiality and the integrity of communications between authentic, authorized workloads and the HMB controllers responsible for managing the memory regions in the HMB. There is also a need to establish unique identities for workloads that access the HMB controller, such that the controller can authorize access to memory regions and prevent workload spoofing.

### SUMMARY

Subject matter included herein discloses solutions to mitigate security threats associated with HMB interfaces including, without limitation, workload identity spoofing threats, in which a malicious workload attempts to spoof a valid workload identity and use the spoofed identity to gain access to a valid workload's HMB region, and, workload verification bypass threats, in which a corrupted HMB controller bypasses or subverts workload verification/authentication actions to grant malicious workloads access to regions that should only be available to authenticated workloads. Accordingly, disclosed subject matter encompasses mutual authentication between an HMB and an authentic workload, i.e., HMB authentication of workloads in combination with workload authentication of HMB controllers.

While mutual authentication is known in networked architectures for connection-equivalent peer applications using, for example, Transmission Control Protocol/Internet Protocol (TCP/IP) and Transport Layer Security (TLS) connections, disclosed subject matter implements mutual authentication across different technology stack layers that cross hardware/software boundaries thereby enabling a mutual-authentication protocol to establish secure sessions encompassing the entire technology stack, rather than just laterally, i.e., amongst peer/companion functionality at equivalent or similar privilege levels.

Disclosed abilities to penetrate through higher-privileged layers of a technology stack while maintaining confidentiality and integrity between workloads in heterogeneous execution environments within a system is beneficial to support above/below OS interactions, enabling general workloads running in higher levels of the stack to interact with very low-level (native) logic that operates within or right at the hardware/software interface layers of the system. Portable workloads in modern workforce and modern client implementations need secure control and transport mechanisms to interact with low-level memory to protect sensitive data in workloads running on the information handling system.

In at least one embodiment, systems and methods disclosed herein respond to detecting an application workload, referred to herein simply as a workload, requesting access to an HMB associated with a nonvolatile storage device of an information handling system by performing mutual authentication operations. The mutual authentication operations may include authenticating the application associated with the workload to the HMB and authenticating the HMB to the application. Responsive to successful completion of the mutual authentication operations, disclosed methods and systems may establish a secure communications tunnel enabling the workload to access at least a portion of the HMB securely.

The nonvolatile storage device may comprise a solid state drive (SSD) and the SSD may comprise an NVMe SSD. In at least some embodiments, the application may comprise an application selected from: an operating system (OS) application, a virtual machine (VM) application, a hypervisor application, a container application, and a firmware application.

In at least some embodiments, disclosed methods and systems perform startup operations prior to detecting the workload requesting access to the HMB, wherein the startup operations include launching the application in a trusted execution environment configured to perform a measured boot of the application to generate an application measurement, such as a hash value generated by applying a suitable hashing algorithm to the application. The application may generate a first public/private key pair including a first public key and a first private key. Similarly, the startup operations may further include launching the HMB in the trusted execution environment to perform a measured boot of the HMB and generate an HMB measurement. The HMB may also generate a second public/private key pair including a second public key and a second private key.

Authenticating the application to the HMB may include storing the application measurement and the first public key in a first register, and sending the application measurement and the first public key to a mutual validation orchestrator, referred to herein simply as the orchestrator. The mutual validation orchestrator may be configured to verify the application measurement and generate an application identity certificate by endorsing the application measurement and the first public key in the first register.

Authenticating the HMB to a workload may include storing the HMB measurement and the second public key in a second register and sending the HMB measurement and the second public key to the mutual validation orchestrator, which is further configured to verify the HMB measurement and generate an HMB identity certificate by endorsing the HMB measurement and the second public key in the second register. The application identity certificate and the HMB identity certificate may each comprise a Secure Production Identity Framework for Everyone (SPIFFE) verifiable identity document (SVID), an IEEE 802.1AR identity certificate, an ITU x509 certificate, or another suitable identity certificate.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an information handling system with features and support for performing dual authentication between an HMB and a valid application workload;

FIG. 2 illustrates a sequence diagram for dual authentication between an HMB and an application workload;

FIG. 3 illustrates a flow diagram of a mutual authentication method;

FIG. 4 illustrates a flow diagram of a mutual authentication operation; and

FIG. 5 illustrates an information handling system suitable for use in conjunction with the methods and systems of FIGS. 1-4.

### DETAILED DESCRIPTION

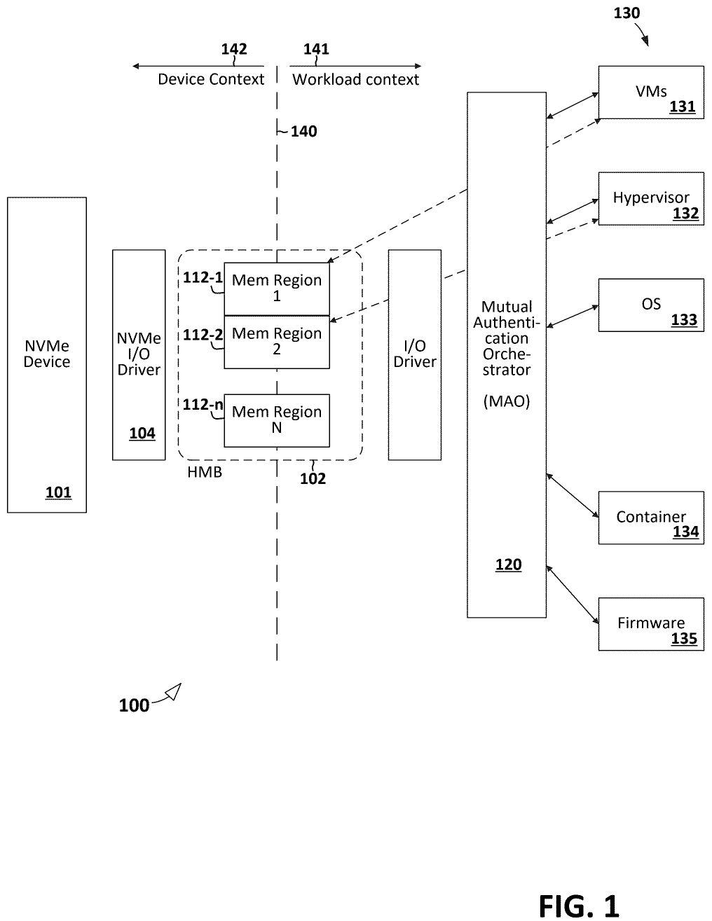

Exemplary embodiments and their advantages are best understood by reference to FIGS. 1-5, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

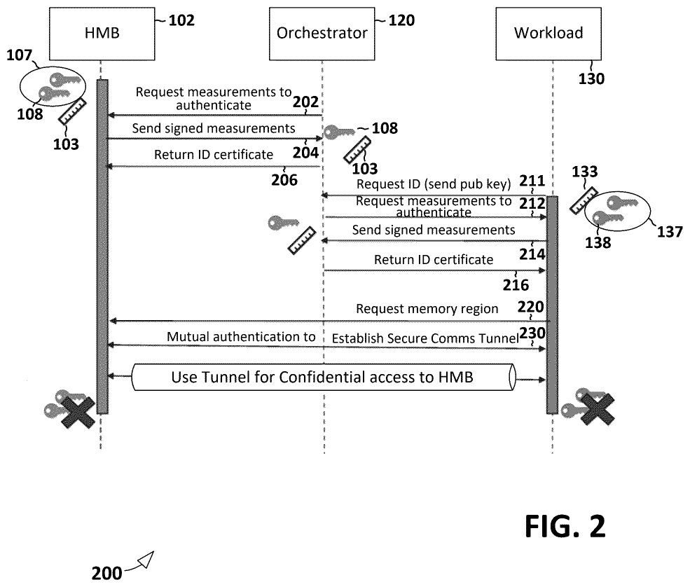

Referring now to the drawings, FIG. 1 illustrates an information handling system 100 with support for mutual authentication between application workloads and an HMB in accordance with disclosed subject matter. As depicted in FIG. 1, information handling system 100 includes an NVMe device 101 and an NVMe I/O driver 104 communicatively coupling NVMe device 101 to an HMB 102. The HMB 102 illustrated in FIG. 1 encompasses a plurality of memory regions 112-1, 112-2, . . . 112-n, each of which is allocated to a specific application workload 130. The exemplary workloads 130 illustrated in FIG. 1 include VM workloads 131, Hypervisor workloads 132, OS workloads 133, Container workloads 134, and firmware workloads 135. Generally, workloads 130 are ephemeral, portable, and do not trust other workloads 130 or HMB 102 unless and until an attestation completes successfully. A mutual authentication orchestrator (MAO) 120 functions as a verifier and identity certificate provider for HMB 102 and workloads 130 and enables workloads 130 to authenticate themselves to HMB 102 and further enables HMB 102 to authenticate itself to workload applications 130. In this manner, MAO 120 enables HMB 102 to uniquely authenticate each workload 130 for access control. Exemplary embodiments of the mutual authentication process supported by MAO 120 are illustrated in FIGS. 2-4 and described in the accompanying text.

FIG. 1 depicts a conceptual boundary line 140 demarcating workload-context resources 141 to the right of boundary line 140, including workloads 130, from device-context elements 142 to the left of boundary line 140, such as the NVMe device 101. Those of ordinary skill in the field will appreciate that workload-context resources 141 comprise information handling resources typically associated with higher layers of a communication interface while device-context resources 142 comprise resources typically associated with lower layers of the communication interface. As an illustrative and non-limiting example based on the open systems interconnection (OSI) model, workload-context resources 141 may represent application layer and/or session layer resources while device-context resources 142 may represent a physical layer and/or data link layer of the communication interface or protocol. In this respect, FIG. 1 conveys an ability of information handling system 100 to implement mutual authentication and establish secure sessions across multiple levels of a technology stack, rather than simply providing lateral connections among peer/companion resources at similar or equal privilege levels.

Referring now to FIG. 2, a sequence diagram illustrates an exemplary mutual authentication sequence 200 enabling mutual authentication between HMB 102 and an application workload 130, sometimes referred to herein simply as workload 130. Sequence 200 may leverage industry standard SPIFFE and SPIFFE runtime environment (SPIRE) frameworks to establish confidential, integrity-protected connections between HMB 102 and workload 130. While SPIFFE/SPIRE frameworks are generally employed for containerized and/or virtualized workloads in datacenter contexts, the sequence 200 illustrated in FIG. 2 binds a SPIFFE/SPIRE framework to platform hardware to enable hardware-to-workload and workload-to-hardware secure communications.

In at least some embodiments, HMB 102 and Workload 130 are launched in a trusted execution environment (TEE). In such embodiments, the TEE performs a measured boot of the controller logic for HMB 102, analogous to a trusted bootloader, e.g., a root of trust for measurement (RTM), that calculates a hash value, referred to herein as a measurement 103 for HMB 102. Similarly, when the application associated with workload 130 is launched, the TEE performs a measured boot of the application to obtain a measurement 133 for workload 130. The TEE in which HMB 102 and workload 130 are launched may be further configured to generate a public/private key pair 107 for HMB 102, including a public key 108, and a public/private key pair 137 for workload 130, including a public key 138, to enable HMB 102 and workload 130 to reliably identify themselves during authentication operations. In at least some embodiments, the measurement 103 and public key 108 for HMB 102 may be combined and stored in a first control status register (not explicitly depicted in FIG. 2) while the measurement 133 and public key 138 for workload 130 may be stored in a second control status register (not explicitly depicted in FIG. 2).

As depicted in FIG. 2, the mutual authentication sequence 200 is managed by MAO 120, which may be a trusted third party entity or resource. MAO 120 sends a request (202) for authentication measurement(s) to HMB 102. In response to the request from MAO 120, HMB 102 returns (204) signed authentication information. The signed authentication information may be generated by HMB 102 by digitally signing the measurement and public key information stored in the first control status register. MAO 120 may download or otherwise access a reference integrity manifest (RIM) or a suitable alternative, generated by the HMB creator or developer, to verify the measurement provided by HMB 102. If MAO 120 successfully verifies the measurement against the RIM, MAO 120 responds by returning (206) an identity certificate to HMB 102. In at least some embodiments, MAO 120 may endorse the identity certificate to HMB 102 by signing the information in the first control status register.

Workload 130, as depicted in FIG. 2, may prompt or otherwise request MAO 120 for an identity certificate. As depicted in FIG. 2, for example, workload 130 requests (211) MAO 120 for an identity certificate by sending its public key 138 to MAO 120. In response, MAO 120 requests (212) workload 130 for authentication measurements and workload 130 responds by providing (214) signed authentication information. The signed authentication information may be generated by workload 130 by digitally signing the measurement and public key information stored in the second control status register. Again, MAO 120 may download or otherwise access a RIM or a suitable alternative, generated by the workload creator or developer, to verify the measurement provided by workload 130. If MAO 120 successfully verifies the measurement against the RIM, MAO 120 responds by returning (216) an identity certificate to workload 130. In at least some embodiments, MAO 120 may convey the identity certificate to workload 130 by signing or endorsing the information in the second control status register.

After identity certificates have been generated for and/or provided to HMB 102 and workload 130, the identity certificates may be used to enable a mutual authentication process initiated in response to a request (220) from workload 130 for an HMB memory region. Successful completion of the mutual authentication process results in the establishment (230) of a secure communication tunnel enabling workload 130 with confidential and exclusive access to an allocated portion of HMB 102.

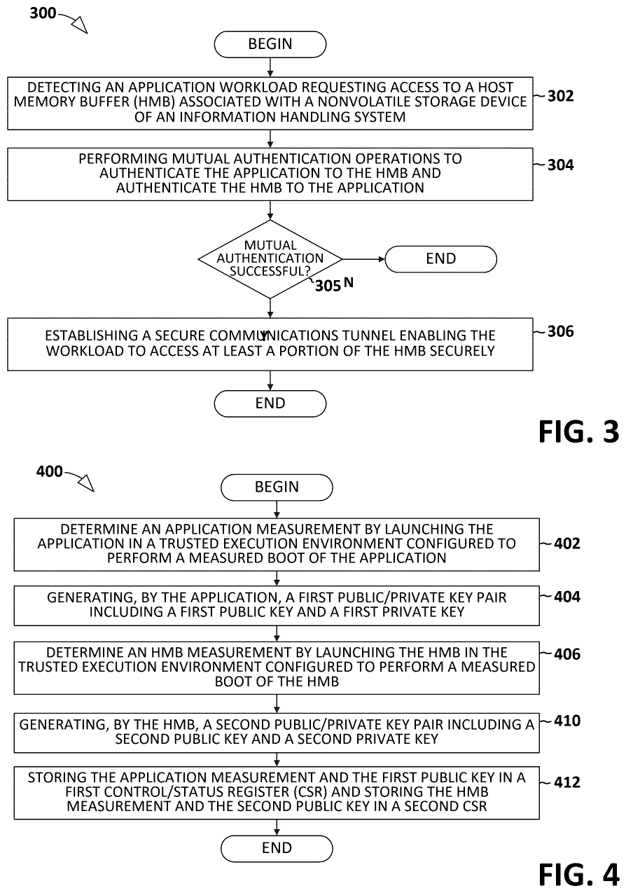

Referring now to FIG. 3, a flow diagram illustrates a mutual authentication method 300 in accordance with disclosed teachings. As depicted in FIG. 3, method 300 begins with the detection (operation 302) of an application workload requesting access to an HMB associated with a nonvolatile storage device of an information handling system. In at least some embodiments as discussed above in the description of FIG. 1 and/or FIG. 2, the nonvolatile storage device may be an NVMe device coupled to a PCIe bus of the applicable information handling system. The illustrated method 300 further includes performing (operation 304) mutual authentication operations to authenticate the workload application to the HMB and authenticate the HMB to the workload application. If, in operation 305, it is determined that the mutual authentication operations successfully authenticate the application workload to the HMB and vice versa, a secure communications tunnel, enabling the application workload to access at least a portion of the HMB securely, is established (operation 306).

Referring now to FIG. 4, an exemplary implementation 400 of the mutual authentication operations 304 of FIG. 3 is depicted. The mutual authentication implementation 400 depicted in FIG. 4 includes determining (operation 402) an application measurement by launching the application in a trusted execution environment configured to perform a measured boot of the application. The mutual authentication implementation 400 depicted in FIG. 4 further includes generating (operation 404), by the application, a first public/private key pair including a first public key and a first private key, launching (operation 406) the HMB in the trusted execution environment to perform a measured boot of the HMB and thereby determine an HMB measurement, and generating (operation 410), by the HMB, a second public/private key pair including a second public key and a second private key. The illustrated implementation 400 further includes storing (operation 412) the application measurement and the first public key in a first CSR and storing the HMB measurement and the second public key in a second CSR.

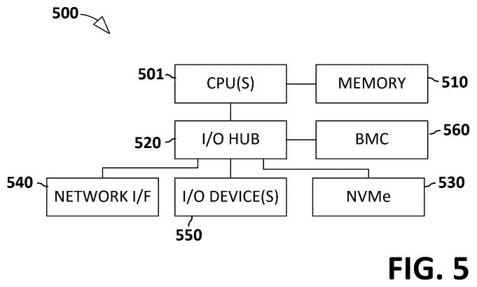

Referring now to FIG. 5, any one or more of the elements illustrated in FIG. 1 through FIG. 4 may be implemented as or within an information handling system exemplified by the information handling system 500 illustrated in FIG. 5. The illustrated information handling system includes one or more general purpose processors or central processing units (CPUs) 501 communicatively coupled to a memory resource 510 and to an input/output hub 520 to which various I/O resources and/or components are communicatively coupled. The I/O resources explicitly depicted in FIG. 5 include a network interface 540, commonly referred to as a NIC (network interface card), an NVMe storage resource 530, and additional I/O devices, components, or resources 550 including as non-limiting examples, keyboards, mice, displays, printers, speakers, microphones, etc. The illustrated information handling system 500 includes a baseboard management controller (BMC) 560 providing, among other features and services, an out-of-band management resource which may be coupled to a management server (not depicted). In at least some embodiments, BMC 560 may manage information handling system 500 even when information handling system 500 is powered off or powered to a standby state. BMC 560 may include a processor, memory, an out-of-band network interface separate from and physically isolated from an in-band network interface of information handling system 500, and/or other embedded information handling resources. In certain embodiments, BMC 560 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method, comprising:
responsive to detecting a workload requesting access to a host memory buffer (HMB) associated with a nonvolatile storage device of an information handling system, performing mutual authentication operations including:
authenticating an application corresponding to the workload to the HMB; and
authenticating the HMB to the application; and
responsive to successful completion of the mutual authentication operations, establishing a secure communications tunnel enabling the workload to access at least a portion of the HMB securely.

2. The method of claim 1, further comprising, prior to detecting the workload requesting access to the HMB, performing startup operations including:
launching the application in a trusted execution environment configured to perform a measured boot of the application to generate an application measurement;
generating, by the application, a first public/private key pair including a first public key and a first private key;
launching the HMB in the trusted execution environment configured to perform a measured boot of the HMB to generate an HMB measurement; and
generating, by the HMB, a second public/private key pair including a second public key and a second private key.

3. The method of claim 2, wherein authenticating the application includes:
storing the application measurement and the first public key in a first register; and
sending the application measurement and the first public key to a mutual validation orchestrator configured to:
verify the application measurement; and
generate an application identity certificate by endorsing the application measurement and the first public key in the first register.

4. The method of claim 3, wherein authenticating the HMB includes:
storing the HMB measurement and the second public key in a second register; and
sending the HMB measurement and the second public key to the mutual validation orchestrator, the mutual validation orchestrator being further configured to:
verify the HMB measurement; and
generate an HMB identity certificate by endorsing the HMB measurement and the second public key in the second register.

5. The method of claim 4, wherein the application identity certificate and the HMB identity certificate each comprise an identity certificate selected from: a Secure Production Identity Framework for Everyone (SPIFFE) verifiable identity document (SVID), an 802.1AR identity certificate, and an x509 certificate.

6. The method of claim 1, wherein the nonvolatile storage device comprises a solid state drive (SSD).

7. The method of claim 6, wherein the SSD comprises a nonvolatile memory express (NVMe) SSD.

8. The method of claim 1, wherein the application comprises an application selected from: an operating system (OS) application, a virtual machine (VM) application, a hypervisor application, a container application, and a firmware application.

9. An information handling system, comprising:
a central processing unit (CPU);
a nonvolatile storage device; and
a memory, accessible to the CPU, including processor-executable instructions that, when executed by the CPU, cause the system to perform steps including:
responsive to detecting a workload requesting access to a host memory buffer (HMB) associated with the nonvolatile storage device, performing mutual authentication operations including:
authenticating an application corresponding to the workload to the HMB; and
authenticating the HMB to the application; and
responsive to successful completion of the mutual authentication operations, establishing a secure communications tunnel enabling the workload to access at least a portion of the HMB securely.

10. The information handling system of claim 9, wherein the steps include, prior to detecting the workload requesting access to the HMB, performing startup operations including:
launching the application in a trusted execution environment configured to perform a measured boot of the application to generate an application measurement;
generating, by the application, a first public/private key pair including a first public key and a first private key;
launching the HMB in the trusted execution environment configured to perform a measured boot of the HMB to generate an HMB measurement; and
generating, by the HMB, a second public/private key pair including a second public key and a second private key.

11. The information handling system of claim 10, wherein authenticating the application includes:
storing the application measurement and the first public key in a first register; and
sending the application measurement and the first public key to a mutual validation orchestrator configured to:
verify the application measurement; and
generate an application identity certificate by endorsing the application measurement and the first public key in the first register.

12. The information handling system of claim 11, wherein authenticating the HMB includes:
storing the HMB measurement and the second public key in a second register; and
sending the HMB measurement and the second public key to the mutual validation orchestrator, the mutual validation orchestrator being further configured to:
verify the HMB measurement; and
generate an HMB identity certificate by endorsing the HMB measurement and the second public key in the second register.

13. The information handling system of claim 12, wherein the application identity certificate and the HMB identity certificate each comprise an identity certificate selected from: a Secure Production Identity Framework for Everyone (SPIFFE) verifiable identity document (SVID), an 802.1AR identity certificate, and an x509 certificate.

14. The information handling system of claim 9, wherein the nonvolatile storage device comprises a solid state drive (SSD).

15. The information handling system of claim 14, wherein the SSD comprises a nonvolatile memory express (NVMe) device.

16. The information handling system of claim 9, wherein the application comprises an application selected from: an operating system (OS) application, a virtual machine (VM) application, a hypervisor application, a container application, and a firmware application.
